(19) United States
(12) Patent Application Publication
(10) Pub. No.: US 2009/0013085 A1
(43) Pub. Date: Jan. 8, 2009

(54) INTERACTION-MANAGEMENT METHODS AND PLATFORM FOR CLIENT-AGENT INTERACTION-RELATED ENVIRONMENTS

(76) Inventors: Hadas LIBERMAN BEN-AMI, Kadima (IL); Michael Prilutski, Alfey Menashe (IL); Naama Damti, Zichron-Yackov (IL); Igor Cher, Rehovot (IL); Leon Gendler, Netanya (IL); Sharona Sagi, Hod HaSharon (IL)

Correspondence Address: Pearl Cohen Zedek Latzer, LLP, 1500 Broadway, 12th Floor, New York, NY, 10036, US

(21) Appl. No.: 12/233,133

(22) Filed: Sep. 18, 2008

Related U.S. Application Data
(63) Continuation-in-part of application No. 11/812,280, filed on Jun. 18, 2007.

(51) Int. Cl. G06F 15/16; G06Q 10/00

(52) U.S. Cl. 709/230; 705/7

(57) ABSTRACT

A platform for enabling collaboration of components of a distributed interaction-related loosely-coupled system, and a method thereof are provided. The platform may include a communication medium and interaction-related business services capable of communicating via the communication medium using an interaction management protocol. The platform may include one or more business process management services to create one or more business flows that utilize one or more of said business services.

### CROSS-REFERENCE TO RELATED APPLICATIONS

This application is a continuation-in-part application of U.S. patent application Ser. No. 11/812,280, filed Jun. 18, 2007 entitled “INTERACTION-MANAGEMENT METHODS AND PLATFORM FOR CLIENT-AGENT INTERACTION-RELATED ENVIRONMENTS” which is incorporated in its entirety herein by reference.

### BACKGROUND OF THE INVENTION

In an interaction-related environment, such as a call center or a contact center, a vast number of client-agents interactions and internal interactions involving personnel of the contact center are held on a daily basis. The systems and applications within the interaction-related environment are responsible for various business flows and hold valuable data. The technological infrastructure may include products from various vendors, each of which may be operated, interfaced and managed separately. For example, retrieving stored customer details may involve one software and/or hardware component, playback of stored calls may involve another component and viewing agent activity may involve yet a third component. There is a need for a platform that would enable managing these systems efficiently, enabling data sharing and/or data analysis, as well as the creation of new business flows, procedures and reports.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a high level block diagram of an interaction-related system according to an exemplary embodiment of the present invention;

FIG. 2 is a block diagram of exemplary communication architecture according to some embodiments of the present invention;

FIG. 3 is a flowchart diagram illustrating an exemplary flow according to some embodiments of the present invention;

FIG. 4 is a flowchart diagram illustrating an exemplary flow according to some embodiments of the present invention;

FIG. 5 is a flowchart diagram illustrating an exemplary flow according to some embodiments of the present invention;

FIG. 6 is a logical block view of a template according to embodiments of the invention;

FIG. 7 is a graphical representation of an exemplary business process template according to embodiments of the invention;

FIG. 8 depicts a system, according to one embodiment of the present invention;

FIG. 9 shows an exemplary screen shot according to embodiments of the present invention; and

FIG. 10 shows an exemplary screen shot according to embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Some embodiments of the present invention are directed to client-agent interaction-related systems, such as call centers or contact centers. In an exemplary client-agent interaction-related environment agents may interact with clients over a telephone network or the Internet and may execute further actions, such as placing orders for products, providing information, or logging customers' details. Additional interactions may include for example internal interactions between personnel. In addition, a typical interaction-related system may comprise platforms and applications providing functionalities and capabilities such as, for example, recording of conversations or events, scheduling of agents' shifts, monitoring of agents activity, analysis tools and performance monitoring. These platforms and applications may be used by the agents as well as by the management and administration of the interaction-related system.

It should be understood to a person skilled in the art that some embodiments of the present invention may be applicable to environments such as trading floors, financial institutions such as banks, or other business organizations. Other environments that may be suitable for employing embodiments of the present invention may be government agencies, network operators or other communication infrastructure operators, for example, cellular or wired phone networks operators.

The technological infrastructure of interaction-related systems typically comprises computer systems, computer software systems, network equipment, storage systems, archiving systems, backup systems and audio or video recording and playback systems. The technological infrastructure may provide functionalities and features such as security enforcement, recording and playback of calls as well as recording and playback of screen activities, work force management, system configurations, performance management, quality monitoring, auditing, and activity monitoring as well as user interface to enable human interaction with the above listed services and features.

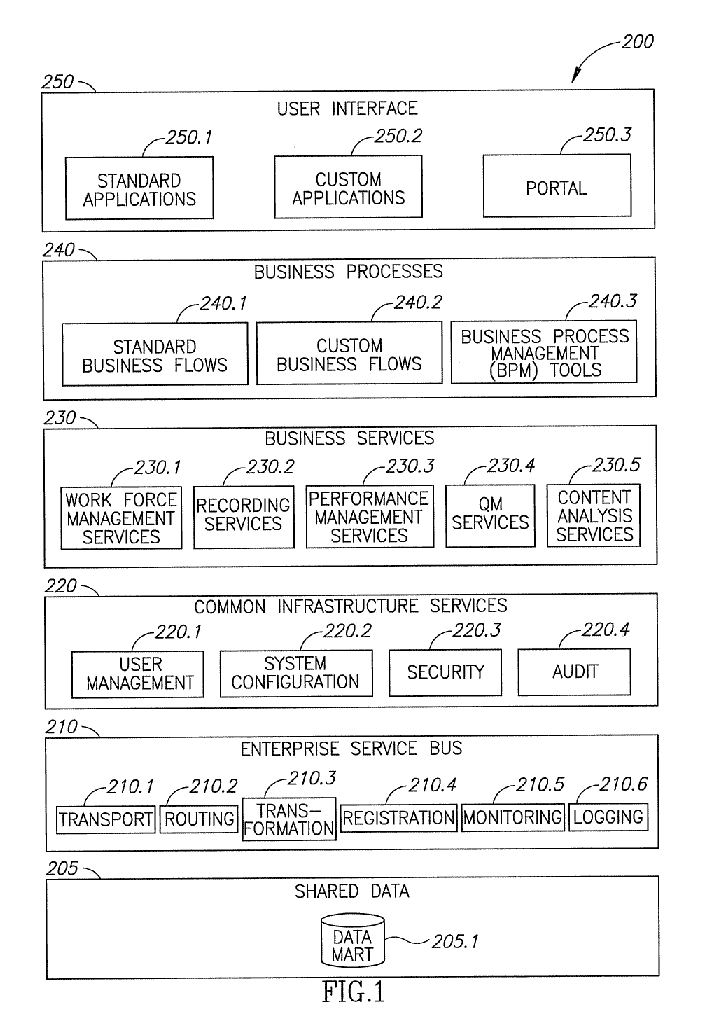

Reference is now made to FIG. 1 which is a logical block view of an exemplary interaction-relation environment according to embodiments of the present invention. The interaction-relation environment may be a contact center, a call center or any other environment involving client-agent interactions as internal personnel interactions. This exemplary embodiment may include a tier-based interaction-management platform (or system) 200, implementing an interaction management protocol where each tier may comprise services which may be requested by other components of system 200. Typically, but not necessarily, services from the upper tiers may request services associated with the same tier or lower tiers. System 200 may include a shared data tier 205, a communication medium tier 210, a common infrastructure services tier 220, a business services tier 230, a business processes tier 240 and a user interface services 250. According to embodiments of the present invention, interaction management platform 200 may provide a brokered service environment to free components of the interaction-related environment from the need to know or deal with certain aspects of a service they require, for example who provides the service, where the provider is or what is the provider's address, as well as various aspects regarding the way provision is implemented.

An executable service may define or perform an execution of one or more computer programs that may provide some functionality. A service provider may return results to a service consumer in the form of a simple indication of success or failure of the service execution or data of various types such as audio stream, an image, a reference to a specific data location, a text string, or a list, such as, for example a list of currently active agents in the interaction-related system. Services may be invoked or interfaced using standard communication protocols such as for example simple object access protocol (SOAP) or hyper text transfer protocol (HTTP). According to embodiments of the invention, the format and sequence of messages exchanged between service providers and service consumers may be predefined, as part of system 200 by the interaction management protocol.

According to embodiments of the present invention, tier-based system architecture 200 may be implemented using service oriented architecture (SOA). As known in the art, SOA is an architectural approach for creating systems built from autonomous services. Using the SOA principals enables creating an environment having loosely-coupled systems that may be integrated while maintaining their autonomous identity as disparate systems. The loosely-coupled systems may share services developed in different programming languages and hosted on disparate platforms with a variety of security models and business processes

Shared data tier 205 may comprise one or more storage units 205.1 to provide shared data storage services. A non-exhaustive list storage services may include storing data in storage, retrieving data from storage, verifying data integrity and querying. According to embodiments of the present invention, upper tiers 210, 220, 230, 240 and 250 may request data storage services from components of shared data tire 205.

Communication medium tier 210 may provide communication and integration infrastructure. Communication medium 210 may be a message-oriented medium, namely, the communication between the components of system 200 may be executed by transferring messages over communication medium 210. According to embodiments of the present invention, components of system 200 may use further entities and interfaces defined by the interaction management protocol to enable efficient communication between various services of system 200. For example, components from various vendors may communicate easily and different versions of services may also communicate with one another using this protocol. Defining business flows that use and aggregate more than one system and sharing data efficiently may be greatly simplified by the interaction management protocol. According to embodiments of the present invention, the use of communication medium 210 as an enterprise service bus may eliminate the need for direct point-to-point communication between each pair of components or systems within the interaction-related environment.

According to embodiments of the present invention, communication medium 210 may be implemented as an enterprise service bus (EBS). Examples for a product that may provide such capabilities may be BizTalk Server of Microsoft, Oracle's Fusion and/or WebSphere of IBM.

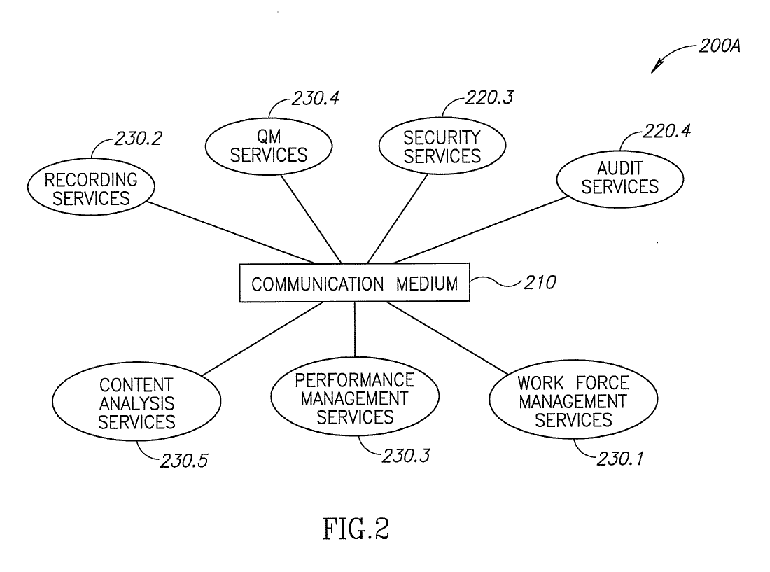

Reference is additionally made to FIG. 2 which is a logical view of an exemplary communication architecture enabling any component supporting the interaction management protocol according to embodiment of the present invention to communicate with any other component supporting that protocol. It should be noted that services may be communicated through communication medium tier 210 using standard communication protocols, such as web services (e.g., SOAP and/or HTTP). According to embodiments of the invention, the services may use the interfaces defined by the interaction management protocol as another layer of standardization on top of communication medium tier 210. For simplicity, in the exemplary interaction-related system 200A, only some components and services connected to communication medium 210 are shown. As depicted in FIG. 2, for example, both recording services 230.2 and performance management services 230.3 are coupled to communication medium 210. Accordingly, the recording system and the performance management application may communicate with each other and with other components over communication medium 210 using the interaction management protocol.

Referring back to FIG. 1, according to embodiments of the present invention, some of the services provided by communication medium 210 may be specifically requested by components of system 200 while other may be part of the functionality of communication medium 210. Communication bus 210 may provide various services such as transport services 210.1, routing services 210.2, transformation services 210.3, registration services 210.4, monitoring services 210.5 and logging services 210.6. It should be understood to a person skilled in the art that embodiments of the invention are not limited to exemplary services 210.1-210.6 and other services may be provided by communication medium 210.

Communication medium 210 in the embodiments of the present invention may serve as a fundamental block in the brokered service environment. Components of system 200 may register services they may provide while possibly other components requiring services may request them without prior registration.

According to embodiments of the invention, transport service 210.1 may include standard protocols such as web services (WS) and/or file transfer protocol. Such protocols may be used for transferring data between various components of system 200, as known in the art.

Routing 210.2 may enable service requests to be routed to a service provider, possibly based on a registration of service providers with communication medium 210. Service providers may register with communication medium 210. A registration may comprise a list of services provided by the registering module. Communication medium 210 may transfer service requests to a registered module base on such registration. Service consumers may register with communication medium 210 as well. For example, Service consumers may be notified of new available services based on registration. Routing 210.2 may relieve a service consumer of the need to be aware of who provides a service. According to some embodiments of the invention, in order to invoke a service, a service consumer may simply communicate a service request to communication medium 210 which may in turn route the service request to the appropriate service provider. According to some embodiments of the invention, a module connected to communication medium 210 may register to receive messages based on messages content. For example, a connected module may register with communication medium 210 in order to receive messages containing alerts.

Transformation service 210.3 may guarantee unified data representation, handling issues such as but not limited to, XML schema transformation. An additional exemplary service provided by communication medium 210 is registration service 210.4 which may enable the discovery of components and services within system 200 by components of system 200. According to embodiments of the invention, when a component of system 200 registers with communication medium 210 other components of system 200 may be notified of its presence as well as the services this newly registered component provides. Registration service 210.4 may hold an updated list of all components and services currently registered with communication medium 210 thus maintaining the ability to respond to queries regarding the availability of components and/or services.

Monitoring service 210.5 may enable monitoring of various parameters of system 200. A non-exhaustive list of parameters may include data rate, message volume and message distribution per component. Logging service 210.6 may log various aspects and parameters associated with system 200, such as, but not limited to, events, alarms and statistics. Logging service 210.6 may be called upon in various ways, such as, but not limited to, periodically, specific request to start logging or by predefined rules. The rules may be associated with various thresholds, various executed services and the like.

According to embodiments of the present invention, common infrastructure services tier 220 may include, for example, a user management service 220.1 to handle the users of system 200, system configuration services 220.2, security services 220.3, and audit services 220.4. It should be understood to a person skilled in the art that embodiments of the invention are not limited to exemplary services 220.1-220.4 and other services may be provided by common infrastructure services 220.

User management service 220.1 may provide services, such as, but not limited to, defining new users, defining user privileges and hierarchy, defining user groups, defining user passwords, user's state, namely, active/inactive state and users profiles. User management service 220.1 may also provide, possibly upon request, information, such as, but not limited to, user profiles, user privileges and user state. According to embodiments of the present invention, users may be defined in system 200 by user management service 220.1. Once defined, a user may request a service or functionality in the entire system 200. According to embodiments of the invention, a central user database may be kept by user management service 220.1. Alternatively, required data may be kept at various databases. Components of system 200 that require, for example, authenticating a user, may access this database by, for example, sending a service request to user management service 220.1 to retrieve the user profile in order to determine attributes, such as, but not limited to, privileges, credentials or access rights.

According to embodiments of the invention, system configuration 220.2 may use the interaction management protocol supported also by other components in system 200 and may provide an interface to configure configurable components and parameters in system 200. This unification of the management component may serve to greatly simplify the configuration task of the interaction-related sub-systems and components of system 200.

According to embodiments of the present invention, security service 220.3 may provide authentication and authorization services to the interaction management platform 200. Security service 220.3 may enable system 200 to handle sensitive data including data required by the authorities to be protected. Money transactions, credit card numbers and shopping lists are a few examples out of many. In addition compliance to various laws and regulations may dictate security enforcement at various levels of the interaction-related system covering aspects, such as, but not limited to, data storage, data transfer, users access rights and privileges, data validation, various auditing, authorization and system deployment.

Security service 220.3 may bring unification of security aspects such as but not limited to security enforcement, user authentication, determining user credentials, and access rights. This unification may be made possible according to embodiments of the present invention, as shown in FIG. 1, where components of system 200 may request services from other components in system 200 with many of the security aspects of the interaction-related systems operation viewed as services, thus for example, defining a new user's privileges may be a service provided by security service 220.3, authenticating a user in order to allow or deny access is another exemplary service security service 220 may provide to other components of system 200, and verifying user credentials is yet another exemplary service.

Security service 220.3 may provide, for example, translation services for security schemas which may vary from a first component of system 200 to another component of the system, thus enabling different components of system 200 to exchange security information even though various aspects of the information may be represented differently by each component. Audit service 220.4 may provide auditing services to components of system 200, such as, but not limited to, software components, processes or flows under different scenarios.

According to embodiments of the invention, business services tier 230 may include for example, work force management services 230.1, recording services 230.2, performance management services 230.3, Quality Management (QM) services 230.4 and Content Analysis services 230.5, all of which are detailed below. It should however be understood to a person skilled in the art that embodiments of the invention are not limited to exemplary services 230.1-230.5 and other services, such as client relation management (CRM) services, accounting services and others may be provided by business services tier 230.

Work force management services 230.1 may handle tasks, such as, but not limited to, shift scheduling of agents, real time adherence to planned schedule, and event scheduling.

Recording service 230.2 may handle recording of various events and activities in system 200, such as, but not limited to, recording of telephonic and web-based client-agent interaction, computer display snapshots, or other recordable forms of activities, states, events or processes. Recording service 230.2 may also provide services related to recorded and/or stored data, such as, but not limited to, searches for recording, requests for playback of recorded information, archiving, deleting or other manipulations of recorded information.

Performance management service 230.3 may be a predefined set of chosen factors that directly or indirectly influence the effectiveness of a product or process, as known in the art. Examples for such factors in the interaction-related system environment may be average call duration, percentage of sales per call and customer wait time. Performance management service 230.3 may provide services, such as, but not limited to, performance management calculation, model building, real time dials showing performance meters, and performance reports, displays and alerts. In the context of embodiments of the present invention, performance management service 230.3 may communicate with other components of system 200 over communication medium 210.

The possibility to communicate with other components of system 200 may enables performance management service 230.3 to perform more efficiently. According to embodiments of the present invention, a host of parameters, measures and data types may be available to performance management service 230.3, many of which are inaccessible to performance management systems running in conventional interaction-related environment architecture. For example, performance management service 230.3, may alert a supervisor when low call rate is detected. Such alerts may be, for example, specific to an agent or per a group of agents.

Quality management (QM) services 230.4 may provide interfaces and services for quality monitoring and quality improvement, such as, but not limited to, creating operational evaluation measures. For example, QM 230.4 may provide a coaching session for an agent.

Content analysis services 230.5 may provide analytics services that include, for example, creating analytics rules that may determine which calls will be analyzed and by which analytic algorithm. A non-exhaustive list of content analysis algorithms may include word spotting, speech-to-text, emotion detection, talk over, or phonetics. According to embodiments of the invention, content analysis services 230.5 may further provide services for analyzing a specific interaction, generating categorizations of interactions and query investigations. Content analysis services 230.5 may use services from other components of system 200 for its tasks.

According to embodiments of the invention, content analysis services 230.5 may communicate with other components of system 200 over communication medium 210. According to embodiments of the present invention, content analysis services 230.5 may trigger events throughout the system. For example, upon identifying an agitated customer, content analysis services 230.5 may use services in order to alert a supervisor to act, or trigger recording of a specific interaction by requesting a service from recording services 230.2 when a predefined condition is identified by a content analysis application.

Business processes tier 240 may be a way of automating, aggregating and collaborating business entities, for example, services, flows and procedures. Business process tier 240 may include the definition as well as possibly scripts and computer programs which may be required in order to execute its tasks. Business process tier 240 may provide functionalities that may incorporate different components of system 200. Tier 240 may include business flows and procedures that may be activated in various ways, for example, by an operator of the system, automatically upon detection of a predefined condition by a component of system 200, or periodically. Business process tier 240 may also provide tools for defining new business flows and procedures. According to embodiments of the invention, business process tier 240 may include for example, standard business flows 240.1, customized business flows 240.2 and process management services 240.3, all of which are detailed below.

Standard business flows 240.1 may be a set of standard, predefined business flows that may be supplied with or built-in the system. Customized business flows 240.2 may be a set of new business flows that may use and aggregate one or more systems within the interaction-related environment. The customized business flows may be implemented according to specific requirements and may be dynamically modified based on the changing requirements and needs. Business process management services 240.3 may be a set of tools used to create new business flows and procedures. A non-exhaustive list of tools may include tools for business activity monitoring, tools to control business flows, tools to create and configure business flows.

User interface tier 250 may provide the operator of the system with a user interface. User interface tier 250 may include standard “off-the-shelf” applications 250.1, customized applications 250.2 and portal services 250.3 which may be a standard or default interface, such as, for example, a web browser.

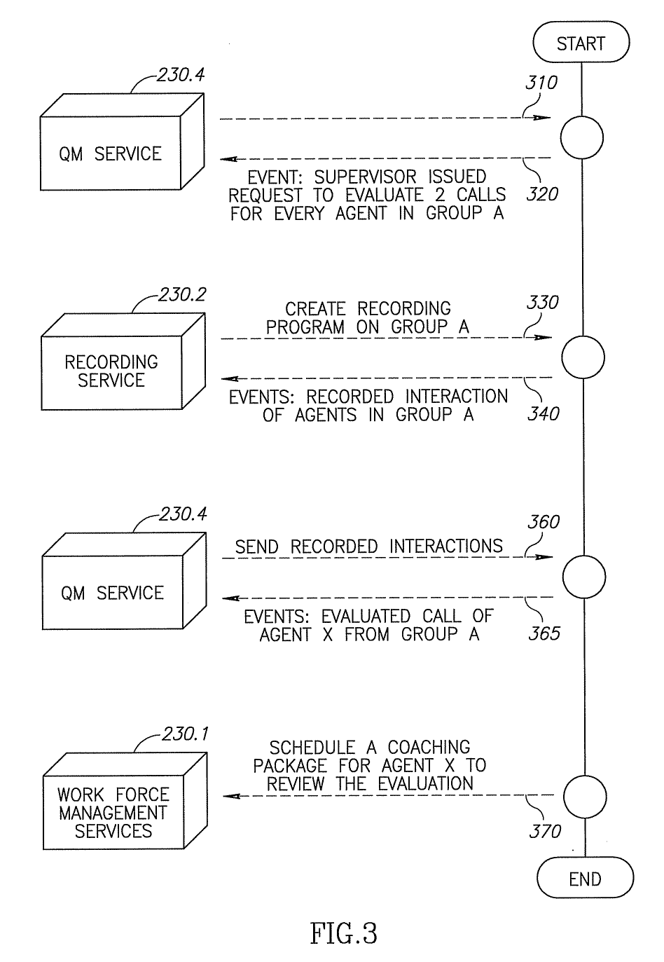

FIGS. 3, 4 and 5 illustrate exemplary business processes within interaction management platform 200 according to exemplary embodiments of the present invention. It should be understood to a person skilled in the art that embodiments of the present invention are not limited to the exemplary business flows depicted herein and that embodiments of the present invention may be implemented with other suitable business flows.

Reference is now made to FIG. 3, which depicts an exemplary business flow according to embodiments of the present invention. The exemplary business flow of FIG. 3 may enable a supervisor of a contact center to define an evaluation form and to request usage of this form to evaluate a predefined number of client-agent interactions for a predefined group of agents. The business flow may be defined as follows: First, using quality management (QM) service 230.4, an evaluation form is created and an event message notifying the creation of the evaluation form is being sent over communication medium 210 using the interaction management protocol (arrow 310). Evaluation form may define, among other things, the methods and criteria by which to evaluate agents, for example, the number of recordings to perform for each agent being evaluated, and various criteria by which to evaluate recorded calls, for example call duration and/or call outcome.

The procedure may be initiated manually by an operator, for example a supervisor or automatically requesting QM service 230.4 to use the evaluation form to evaluate a predefined number of calls (e.g. 2 calls) for each agent associated with a predetermined group of agents. Next, a request to use the evaluation form initiated by QM service 230.4 is being delivered over communication medium 210 using the interaction management protocol (arrow 320). Accordingly, the request initiated by QM 230.4 may include a request for a recording service from recording services 230.2.

Consequently, a recording program may be created and delivered to recording services 230.2 over communication medium 210 using the interaction management protocol (arrow 330). As a result of the recording program, the requested client-agent interactions may be recorded and recording services 230.2 may return the recorded data over communication medium 210 using the interaction management protocol (arrow 340). The recorded client-agent interaction may be sent to QM services 230.4 (arrow 360). QM services 230.4 may perform the task of evaluating the recordings. Once the evaluation on a particular agent is completed, QM services 230.4 may send an event message over communication medium 210 using the interaction management protocol notifying that the evaluation of the agent was completed (arrow 365).

Consequently, a request to schedule a meeting between the agent and his supervisor to review the evaluation form may be sent to work force management service 230.1 over communication medium 210 using the interaction management protocol (arrow 370). As a result, work force management service 230.1 may schedule the meeting.

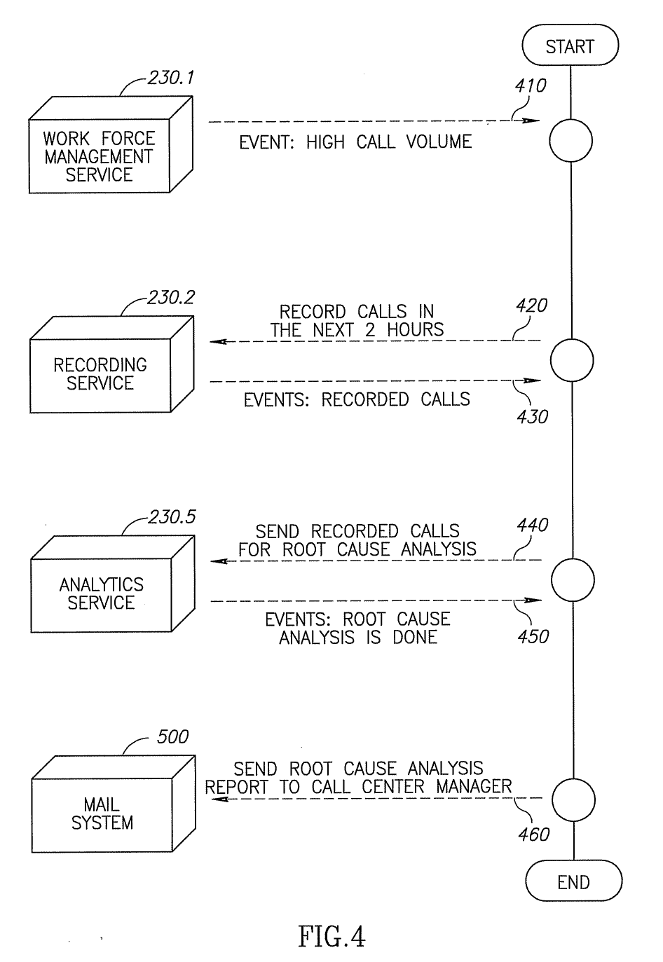

Reference is now made to FIG. 4, which depicts an exemplary business flow according to embodiments of the present invention. The exemplary business flow of FIG. 4 may enable a supervisor to analyze the reasons for high volumes of incoming telephone calls. The business flow is defined as follows: The flow may begin whereby, upon detection of volume of calls above a predefined value, work force management service 230.1 may send an event message notifying the high volume of calls over communication medium using a interaction management protocol (arrow 410).

Consequently, a request to record all calls during a predefine period of time may be sent to recording services 230.2 over communication medium 210 using the interaction management protocol (arrow 420). Upon completion of the requested recording, recording services 230.2 may send an event message notifying that the calls have been recorded over communication medium 210 using the interaction management protocol (arrow 430).

Next, a request to perform word spotting and categorization of these calls may be sent to content analysis service 230.5 over communication medium 210 using the interaction management protocol (arrow 440). As a result, content analysis service 230.5 may perform the content analysis and send an event message notifying the completion of the analysis over communication medium 210 using the interaction management protocol (arrow 450). Consequently, a message to a mail system 500 may be sent over communication medium 210 using the interaction management protocol (arrow 460). As a result, the mail system may send mail to a predefined recipient list possibly containing predefined content, for example, mail sent may contain the analysis results or it may contain other information pertaining to the execution of the flow.

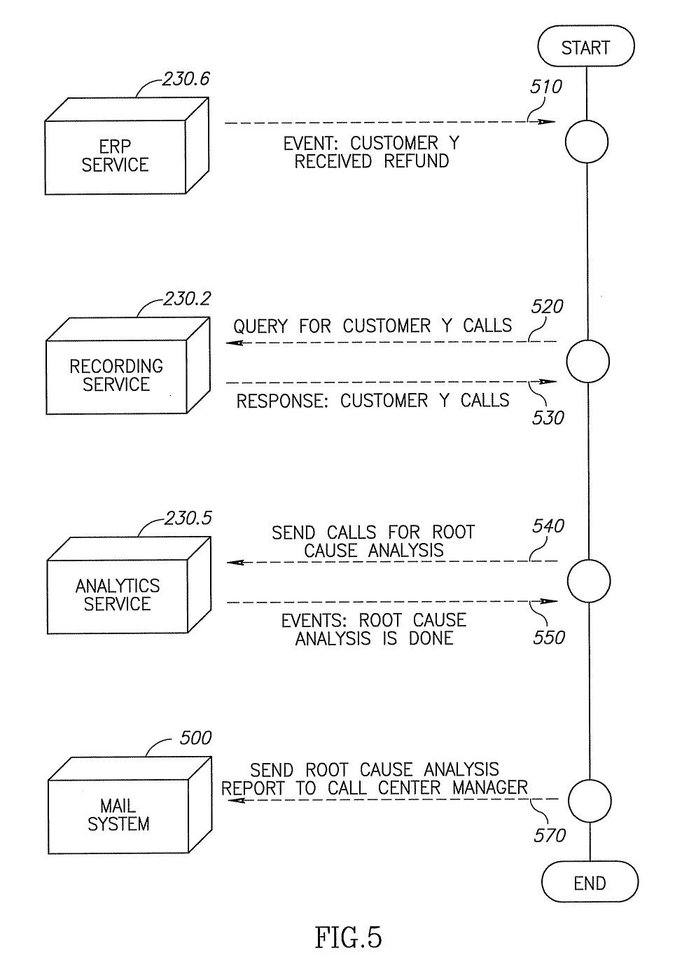

Reference is now made to FIG. 5, which depicts an exemplary business flow according to embodiments of the present invention. The exemplary business flow of FIG. 5 may enable a supervisor to analyze agent-client telephonic interaction that involved refunding the client at an amount above a predefined value. The business flow is defined as follows: First, using an Enterprise Resource Planning (ERP) service 230.6, a datum related to a customer being refunded above a predefined value is detected (arrow 510) and an event message notifying the finding is being sent over communication medium 210 using the interaction management protocol.

Consequently, a request for a search of all calls associated with that customer may be sent to recording services 230.2 over communication medium 210 using a interaction management protocol (arrow 520). Recording services 230.2 may send the requested data to shared data storage and upon completion, recording services 230.2 may send over communication medium 210 using the interaction management protocol an event message notifying that the requested data was uploaded as requested (arrow 530).

Next, a request to perform word spotting and categorization of these calls may be sent to content analysis service 230.5 over communication medium 210 using the interaction management protocol (arrow 540). As a result, content analysis service 230.5 may perform the content analysis and send an event message notifying the completion of the analysis over communication medium 210 using the interaction management protocol (arrow 550). Consequently, a message to a mail system 500 may be sent over communication medium 210 using the interaction management protocol (arrow 570). As a result, the mail system 500 may send mail to a predefined recipient list possibly containing predefined content, for example, mail sent may contain the analysis results or it may contain other information pertaining to the execution of the flow.

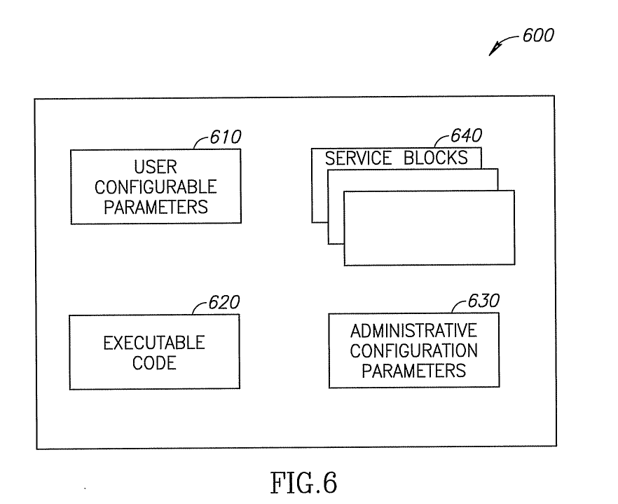

According to embodiments of the invention, software defining and implementing business flows such as those described with reference to FIGS. 3, 4 and 5 and/or custom business flows 240.2 may be provided as part of business packages or business process templates. For example, NICE Systems Ltd. of Ra'anana, Israel, may provide such templates to end users of systems such as described herein, although other templates, and other objects discussed herein as being provided by NICE Systems, Ltd., may be used. According to embodiments of the invention, business packages or business process templates may be provided in for example ways software packages are typically provided, e.g., on a compact disk (CD) or downloaded from a server, e.g., from an Internet site. The terms “business package”, “business process template” or simply “template” may refer to a software package comprising an implementation of a business flow, configuration files and other auxiliary files as described for example with reference to FIG. 6. The terms “business package”, “business process template” and/or “template” may be used interchangeably herein.

According to embodiments of the invention, a business package or template may comprise definition and implementation of a logical business flow and may further comprise configuration parameters, possibly in separate files. For example, a template may comprise executable code or script, e.g., a Java™ script or a software application that may implement a specific business flow, for example, the flow described with reference to FIG. 5. According to embodiments of the invention, a template or package may also comprise one or more configuration files. For example, a file containing values of various parameters may be part of a business package or a template. According to embodiments of the invention, the executable code implementing a logical flow may be configured to extract parameters values when required from such configuration files.

According to embodiments of the invention, a template may comprise, use, activate, refer to or be otherwise associated with service blocks. According to embodiments of the invention, a service block may be delivered as for example a software package comprising executable code and accompanying files storing configuration parameters or other information that may be required in order to activate one or more services. Accordingly, a service block may be referred to herein as an executable service block. According to embodiments of the invention, service blocks may activate any applicable service. For example, any one of common infrastructure services 220 or business services 230 may be activated by a service block. Exemplary service blocks may include for example a recording service block, a work force management service block, an analytics service block, a mail service block, an ERP service block, a playback service block, a security service block, a storage service block, a logging service block and a QM service block.

According to embodiments of the invention, a service block may comprise any suitable software objects required for activating such services. For example, a service block may comprise executable code for calling or otherwise interfacing with a service provider as well as any configuration files that may store various parameters controlling or otherwise affecting the interaction of the service block with service providing entities.

According to embodiments of the invention, a service block may be loaded into memory and executed. For example, a script may call a service block in a way similar to how a dynamic library or external programs are called. According to embodiments of the invention, various parameters of a service block may be modified or configured by a user. For example, a notification service block may be configured to use electronic mail as it's primary method of notifying users of various events. Alternatively, a user may configure such notification service block to use a paging system, a facsimile machine or any other applicable means. Another configuration parameter of such service block may be the list of recipients to receive notifications, e-mail addresses etc. Such configuration parameters may be stored in configuration files contained in a service block as described.

According to embodiments of the invention, a service block may provide an abstraction of a service. For example, a recording service block may provide an abstraction of recording services by hiding various details such as session initiation with a recording system, or various configuration or other tasks that may be required for controlling a recording system. According to embodiments of the invention, service blocks may be activated or otherwise utilized by business processes or templates. For example, if the business flow defined by a template requires recording services then a recording service block may be called or activated by the executable code comprised in the template.

According to embodiments of the invention, a plurality of business process may be defined or created by applying a respective plurality of configurations to a single business process template. According to embodiments of the invention, the resulting business processes may be saved on a storage device and may, at a later stage be invoked according to a user selection. A single business template or package may be used to create a number of business processes. For example, a user may edit a business process template by changing configuration parameters of some of the service blocks, remove or add service blocks from/to the business flow and may further store the modified template as a business process. According to embodiments of the invention, a business processes may be regarded as an instantiation of a business template. Although a business template as provided to an end user may be executed without any modification, users may typically alter various aspects of a template and save such modified template as a business process, possibly associating it a meaningful name, e.g., “call volume evaluation process” or “agent attrition analysis process”. According to embodiments of the invention, a saved or stored business process or template may be loaded into a memory (short term or long term) of a computing device and executed.

According to embodiments of the invention, a graphical user interface (GUI) software tool may enable users to graphically manipulate service blocks associated with a template or business process. A user may add service blocks to a business process or template, remove service blocks or manipulate various configuration parameters associated with a service block. For example, a recording service block may enable a user to alter parameters such as recording quality, maximum recording time of a given session etc.

A service block may comprise one or more executable services. For example, a recording service block may comprise one or more recording services as described, for example, with reference to recording services 230.2. Business packages may further comprise logic to control the associated flow. For example, business packages may define conditions according to which a flow may utilize, traverse or otherwise comprise a first subset of a set of service blocks under a first set of conditions but traverse, utilize or otherwise comprise a second subset of a set of service blocks under a second set of conditions or circumstances.

Reference is now made to FIG. 6 showing a logical block diagram view of a template 600 according to embodiments of the invention. Template 600 may comprise user configurable parameters file 610, an administrative parameters file 630, executable code 620 and a number of service blocks 640. Template 600 may be provided, for example by NICE Systems Ltd. to end users such as an operator of an interaction related facility such as a call center, a customer relation department in a bank and the like. According to embodiments of the invention, template 600 may be loaded into a memory of a computing device, e.g., a server and may be further executed. According to embodiments of the invention, an execution of business template 600 or a business process derived from template 600 may comprise an execution of the associated flow as described with reference to FIGS. 3, 4 and 5.

As shown by block 610, a template may comprise user configurable parameters. For example, 610 may be one or more configuration files containing parameters definitions. Each parameter in such file may be represented by an entry, e.g., in a list. According to embodiments of the invention, a parameter entry may comprise a number of fields defining various aspects of the associated parameter. For example, an exemplary field in a parameter entry may define the type of the parameter, for example, numeric, textual, boolean or other. The type field and other fields may be used to verify that configuration input from a user is in the correct and expected format. For example, if the call volume level is defined by a numeric value of calls per hour then attempting to change such value by providing a text string such as “three calls a second” may cause an error message to be presented to the user as a result of detecting that the supplied input does not conform with the format of the expected value.

Other fields in a parameter entry in user configurable parameters 610 may be for example maximum and/or minimum values allowed, and permission related fields. For example, some entries or fields may only be altered by personnel with specific authorization levels. Accordingly, an entry or field may comprise information enabling a verification that the user attempting to modify an entry is indeed authorized to do so. For example, the flow described with reference to FIG. 3 may be provided as a template. Accordingly, parameters such as the number of client-agent interactions to record for the evaluation process, the group of agents to evaluate, whether the process or flow is to run automatically or manually, if the flow is to be executed automatically then at what time of day, day of week etc., may be stored in user configuration parameters 610.

Alternatively, the flow described with reference to FIG. 4 may be provided as a template and accordingly, relevant parameters may be configured. For example, parameters such as the value defining a high volume of calls, the recording duration of calls and words to be searched by a word spotting process executed by content analysis service 230.5 as described, the recipient list to be notified and the content of the notification sent, may be configured by a user and stored in user configurable parameters 610. Similarly, parameters such as the amount above which the flow described with reference to FIG. 5 is to be executed may be configured by a user using a template for creating a specific business flow or business processes.

According to embodiments of the invention, a template or package may comprise a number of configuration files or structures. For example, as shown by administrative parameters 630, possibly in addition to user configurable parameters 610, administrative or other administrative parameters file 630 may be defined and stored in additional files. Such additional parameters may be or describe, for example, specific events that may cause a termination or initiation of an execution of the associated flow. For example, detection of a fault or failure to complete a task by a service block may be defined as an event that may cause the associated flow to terminate. Other administrative parameters may be scheduling parameters. According to embodiments of the invention, scheduling information, e.g., the number of times to run a business process, the time to run etc. may be stored in administrative parameters 630. According to embodiments of the invention, any other applicable events, conditions and/or parameters may be defined in 630 and may be observed when the associated business process is executed.

According to embodiments of the invention, configuration file 630 may store information such as APIs information and/or addressing information. Such information may be used by code 620 implementing the flow and/or by service blocks 640. For example, API related information may enable executable code 620 to interact with various components of system 200. According to embodiments of the invention, addressing information such as Internet protocol (IP) addresses contained in 630 may be required and used by executable code 620 or service blocks 640 in order to interact with various components, applications and/or computing devices. According to embodiments of the invention, a plurality of business processes may be defined or derived by applying a respective plurality of parameter sets to a single business process template, storing the resulting business processes and then, or at a later stage, selecting from storage one or more of the business processes to be executed.

According to embodiments of the invention and for example as shown by block 620, a template may comprise a definition and software implementation of a logical business flow, business process, or simply, a flow. Code 620 may be a script, program or any other applicable computing machine executable instruction set. Such executable code may implement the logic required in order to execute the flow of the associated business process. For example, the sequence of: requesting calls from recording service 230.2, receiving such calls recordings, providing the recordings to analytics service 230.5, receiving analytics results and causing mail system 500 to distribute mail for example as described with reference to FIG. 5 may be implemented in a script or other executable code. Non-configurable conditions related to a flow may also be defined or embedded in such code. For example, failure to communicate with a required service may cause a flow, and accordingly, a business process to terminate. Such termination may be hard-coded in the executable code implementing the flow.

According to embodiments of the invention, service blocks 640 may comprise definitions and code for activating a business service such as QM service 230.4, recording service 230.2 or work force management services 230.1. Service blocks 640 may interact with service providing entities according to well defined protocols or definitions. For example, service blocks 640 may interact with various components of system 200 according to SOA principles. Service blocks may be defined, implemented and provided by a provider of the business templates, e.g., NICE Systems Ltd (although, as with other objects noted as being provided, other sources may be used). According to embodiments of the invention, service blocks 640 may be activated or called by code 620. For example, a template may comprise an activation of a number of service blocks. Such activation may be according to the business flow, as defined, for example, by executable code 620. For example, if the flow comprises recording calls then a recording service block may be called or activated by code 620, put differently, the flow may comprise activating a recording service block.

According to embodiments of the invention, service blocks may be provided as part of a provided business template as shown by service blocks 640 or they may be provided separately. According to embodiments of the invention, a set of service blocks may be shared by a number of templates. According to embodiments of the invention, template 600 may be provided to an end user as a software package stored on any suitable media, sent by electronic mail, downloaded from the Internet or by any other applicable means. Template 600 may be stored on any applicable storage device, e.g., a hard disk attached to a server in a call center. Template 600 or a business process derived by editing or manipulating template 600 as described may be loaded into memory of a server or any other applicable computing device and may further be executed, for example, by causing code 620 to be executed by a processor of a computing device.

According to embodiments of the invention, parameters associated with service blocks 640 may be stored in user configuration parameters 610, in administrative parameters 630 or in other (not shown) files or objects. Subsequent to modifying parameters related to service blocks 640, the resulting modified template definition may be saved as a business process. According to embodiments of the invention, service blocks provided with business packages or templates may be configured to use APIs as defined and/or provided by devices or applications in a specific site. For example, a specific recording system from a specific vendor may define specific APIs. Accordingly, a recording service block may be configured to use those specific APIs. Such configurations may be done by personnel installing or providing the template or by users, for example upon replacing a relevant component on a site. Alternatively or additionally, service blocks may be SOA compliant. As such, service blocks may be configured, possibly as a default configuration, to interact with relevant entities according to SOA definitions. For example, SOAP or HTTP may be used.

According to embodiments of the invention, a template may contain a definition of a flow such one of the flows described with reference to FIGS. 3, 4 and/or 5. According to embodiments of the invention, a template may further contain configurable parameters that may control an execution of the associated flow and conditions according to which such flow is to be executed. For example, a template may define events that may cause the associated flow to be executed, events and/or conditions according to which the flow may terminate and parameters affecting the flow execution. According to embodiments of the invention, such events, conditions and parameters may be configured and/or otherwise manipulated by users of such templates. According to embodiments of the invention, a business process template may be obtained (and possibly stored in a memory, such as memory 830, discussed below), for example from NICE Systems Ltd., may further be modified by configuring one or more service blocks associated with the business process template and the resulting, modified template may be executed.

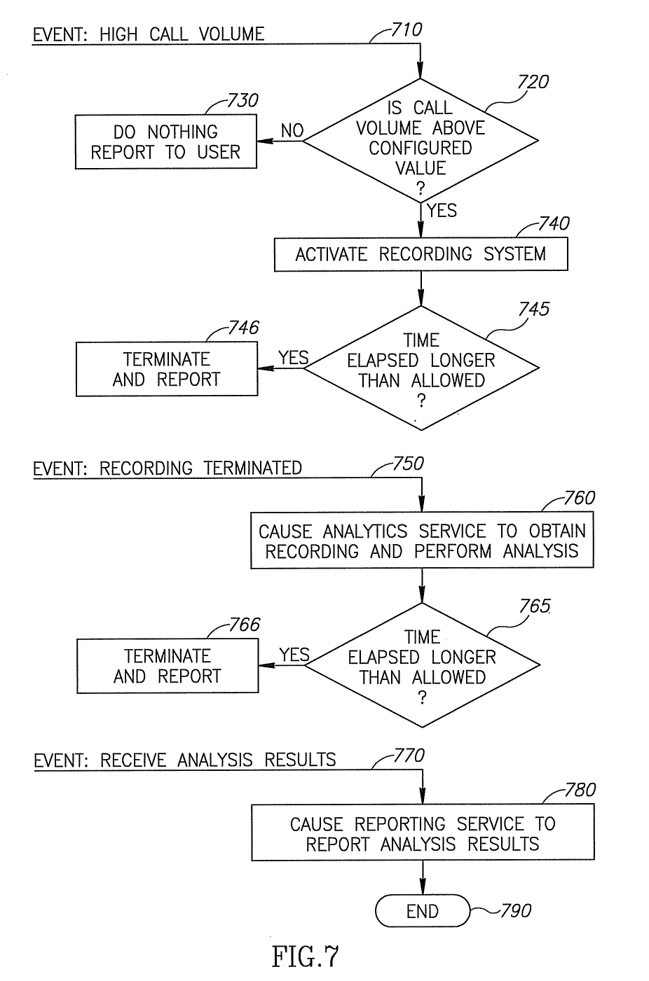

Reference is made to FIG. 7 showing a graphical logical representation of an exemplary business process template. A template such as that shown in FIG. 7, or a business process derived from such template, may be activated for example upon detecting a high call volume in a contact center. Other exemplary business processes or templates may be, for example, a first call resolution (FCR) business process or template that may resolve, categorize, log or otherwise manage a call from a new customer. Another exemplary business package may be an agent attrition business process or template. Such a template or process may handle agent attrition related issues by performing relevant tasks, e.g., evaluate work satisfaction, monitor attrition rate across departments, etc. Yet another example of a possible business process or template may be a customer satisfaction business template or a customer retention business process template. Such templates may be used as a business process or as a template for creating business processes that evaluate, measure, monitor or are otherwise associated with customer satisfaction and/or retention. According to embodiments of the invention, exemplary service blocks that such business packages may include, for example, a feedback service block, an audio analysis service block, an agent input service block and/or a historical data acquisition service block. According to embodiments of the invention, any applicable business package may be defined and implemented.

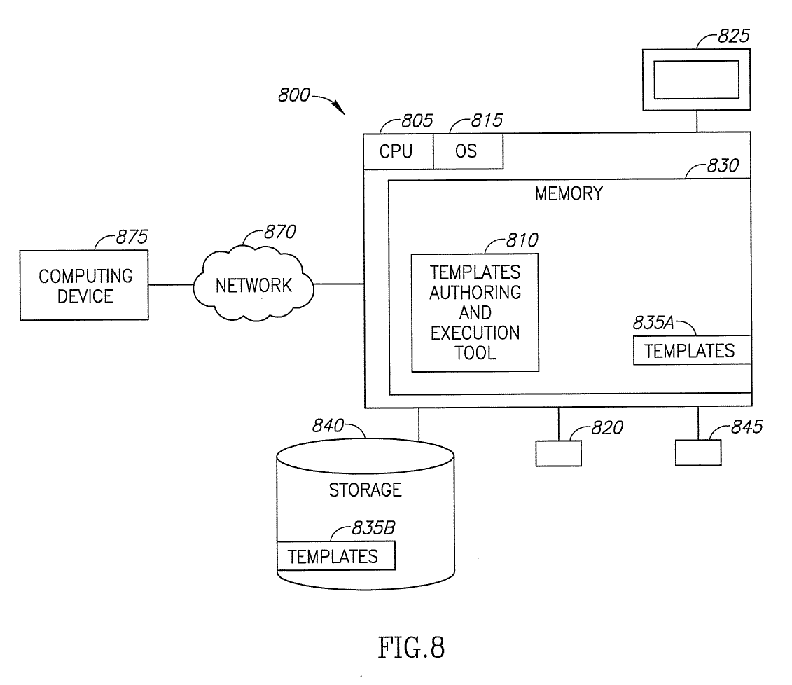

According to embodiments of the invention, the flow depicted in FIG. 7 may be implemented by for example a software package. For example, logic, activation of services etc. in the flow shown in FIG. 7 may be implemented by executable code 620 that may be executed by CPU 805 described with reference to FIG. 8, possibly utilizing one or more configuration or other files such as parameters 610 or 630 and possibly utilizing service blocks such as service blocks 640 described with reference to FIG. 6. Executable code 620 may be. As shown by 710, a template associated with the flow may comprise a definition of an event or condition that may cause the associated flow to commence or be executed. For example and as shown by 710, such an event may be a message or other notification from work force management service 230.1 indicating that a high call volume has been detected. Other events or conditions may be included. Multiple conditions or events may activate a flow. Accordingly, a template may comprise logic, for example, in executable code 620, to verify that the received event is indeed one that should cause the associated flow to be executed. According to embodiments of the invention, an event causing a flow execution to start may be a configurable parameter, for example, the business package or template may comprise a file containing a list of events that may cause the flow to be executed. Other types of events may be included. An end user, for example an administrator in a call center, may alter events or such an event set or list by, for example, adding to or removing from the list or set events that may cause the flow to be executed.

In 720, the flow may include determining that the call volume is actually above a predefined level. A predefined call level may be set by a provider of the template, however, the call level may be a parameter configurable by an end user of such template. For example, a small call center may regard a specific call volume as high while a larger facility may regard the same call volume as low. Accordingly, users in the respective facilities may configure their respective templates to reflect their respective desired thresholds of call volume, or of other parameters. Such configuration parameters may be stored in parameters 610 described with reference to FIG. 6. Accordingly, executable code 620 may be configured to extract the value stored in parameters 610 and verify that the reported call volume shown by 710 is indeed regarded as high volume. Upon receiving an indication as shown by 710, executable code 620 may compare the received call volume value with a value stored in user configuration parameters 610 and determine if the call volume is indeed high, and for example requires an execution of the flow.

In block 730, if the level of call volume is determined to be under the threshold level, then the flow may perform one or more actions. Such actions may be defined and/or configured by an end user. For example, the flow may terminate without performing any additional tasks. Alternatively, a user may configure the template to cause the flow to report such termination to a specific recipient list of users or users groups. Such list may be another example of configurable parameters of a template or business flow.

In block 740, the flow may comprise activating a recording service, for example, recording service 230.2. According to embodiments of the invention, various parameters associated with such activation may be configurable. For example, a user may configure the duration of the recordings, the agents to be recorded or the recording quality as well as select a specific recording system from a possible number of recording systems associated with recording service 230.1. Such parameters may be preconfigured by a provider of the template but may be reconfigured by an end user to better suit a specific site.

In block 745, the flow may comprise a wait state allowing the recording to be performed. According to embodiments of the invention, the time a flow may allow for the recording to be completed may be a configurable parameter. Such a parameter may be configured by an end user according to various considerations such for example as the recording speed and/or capacity of the relevant recording system or the recording duration configured as described above. The wait state duration may be another example of a configurable parameter of a template. If a recording termination indication is not received within a specific time period, the flow may terminate as shown by block 746. According to embodiments of the invention, by configuring the associated template, a user may determine actions to be performed upon such termination, for example, a preconfigured list of users may be notified of such termination of the flow. The time to allow for the recording to complete may be stored configuration files such as those described (610, 630). Accordingly, code 620, when executed, may extract the time value from a configuration file and use such value to determine when the allowed time has lapsed.

In block 750, the template, e.g., code 620, may comprise a definition of an event to cause the flow to proceed or resume execution. As shown, such event may be a notification, for example from recording service 230.1, that the recording has completed. For example, code 620 may be configured to expect a notification from recording service 230.2 and resume execution of the flow, code 620 may further be configured to ignore any other notification during such time. According to embodiments of the invention and as shown by 760, upon receiving such an indication, the flow may comprise causing an analytics module such as one supported by analytics service 230.5 to obtain the recordings and to perform various analytics on these recordings. As described with reference to analytics service 230.5, various analytics may be performed by this service. Accordingly, the template may comprise specific definitions of analytics to be performed. For example, if the flow is to evaluate the reasons for a high call volume then the analytics requested as shown by bock 760 may be directed at, for example, call duration, call result etc. According to embodiments of the invention, any applicable parameters pertaining to the requested analytics may be configured by the user by changing the possibly preconfigured parameters that may be in place when the template is fist provided to the user. For example, an analytics service block may be used as described, accordingly, parameters pertaining to analytics may be part of the configuration parameters of such service block.

In block 765, the flow may comprise a wait state allowing the analysis task to be performed. According to embodiments of the invention, the time a template's flow may allow for the analysis to be completed may be a configurable parameter as described with reference to block 745. Such parameter may be configured by an end user according to various considerations such as the capacity of the analytics service, the complexity of the required analyses, the volume of data to be analyzed and the like. Such wait state duration may be another example of a configurable parameter of a template. According to embodiments of the invention, if an indication that the analysis task is not received within a specific time period, the flow may terminate as shown by block 766. According to embodiments of the invention, by configuring the associated template, a user may determine actions to be performed upon such termination, for example, a preconfigured list of users may be notified of such termination of the flow.

In block 770, the template may comprise a definition of an event to cause the flow to proceed or resume execution. As shown by 770, such event may be a notification, for example from analytics service 230.5, that the analysis task has completed. Such an event may further be accompanied by the analysis results. In block 780, the flow may send the analysis results to a reporting system. According to embodiments of the invention, a provided template may utilize a reporting service block. The specific reporting system may be a configurable parameter. For example, a user may configure a reporting service block used by the flow to use for example a paging system or electronic mail, causing alert messages to be displayed on predefined computer displays, a combination of some of the above examples or any other suitable and/or available reporting means on a specific site or facility. According to embodiments of the invention a user may further configure other parameters, e.g., a recipient list of users or personnel to be provided with the analysis results. In block 790, a termination point may be defined for a flow. According to embodiments of the invention, a user may configure various operations or tasks to be performed upon termination of the flow, for example, any required cleanup tasks, reporting tasks or logging procedures may be defined by a provider of the template and may be reconfigured by an end user of such template.

Reference is made to FIG. 8 showing a computing device 800 capable of performing authoring and execution of business processes and/or templates, and other methods discussed herein. According to embodiments of the invention computing device 800 and installed software may enable a user to execute business processes. For example, possibly subsequent to manipulating a business package template and saving the resulting business process, a user may cause such business process to be executed by utilizing software installed on computing device 800.

According to embodiments of the invention, computing device 800 may include a memory 830, central processing unit processor (CPU) 805, monitor 825, storage device 840, an operating system 815, input device(s) 820 and output device(s) 845. According to embodiments of the invention, storage device 840 may be any suitable storage device, e.g., a hard disk, input devices 820 may include a mouse, a keyboard or any suitable input devices and output devices 845 may include one or more displays, speakers and/or any other suitable output devices. According to embodiments of the invention and as shown by 835B, business processes templates may be stored on storage device 840. For example, business packages templates 835B provided to a user by NICE Systems Ltd. may be stored on storage device 840. According to embodiments of the invention and as shown by 835A, business processes templates may be stored in memory 830. For example, business templates may be loaded into memory 830 from storage 840 and may be manipulated in or executed from memory 830 by tool 810.

According to embodiments of the invention, software tool 810 may enable a user to manipulate business processes templates, save such templates as ready to run business process. Tool 810 may further enable a user to locate on storage, load and execute such business processes. Software tool 810 may comprise a graphical user interface module that may enable a user to graphically manipulate a business process, packages or template. Tool 810 may enable a user to execute a business process and further track or monitor the progress of such executed business process. Computing device 800 may be connected to network 870 that may be any suitable communication infrastructure that may enable computing device 800 to communicate with other computing devices, e.g., computing device 875. Computing device 875 may be a recording system, a mail server or any other computing device. According to embodiments of the invention, during an execution of a business process, computing device 800 may communicate with computing device 875. For example, if computing device 875 is a recording system and the business process being executed by device 800 requires recording services then device 800 may communicate with device 875 and cause device 875 to perform the required recording task.

According to embodiments of the invention, using input and/or output devices connected to computing device 800 a user may cause templates 835B to be loaded from storage 840 into memory 830. According to embodiments of the invention, a user may further cause a template business processes derived from templates to be executed, for example, by using software tool 810. According to embodiments of the invention, tool 810 may cause CPU 805 to execute instructions that may cause a flow as for example described with reference to FIG. 7 to be executed.

According to embodiments of the invention, a software tool, e.g., tool 810 described with reference to FIG. 8, may be provided for configuring, authoring, or otherwise manipulating business packages and defining business processes as described. Tool 810 may comprise a graphical user interface (GUI) module enabling a user to graphically define, change or otherwise manipulate business processes or template by for example adding and/or removing service blocks, changing configuration parameters of service blocks.

Tool 810 may enable a user to invoke, activate or execute a business process by activating executable code 620. According to embodiments of the invention, tool 810 may also be used to schedule future and/or periodic execution of business processes. Tool 810 may enable a user to monitor an execution of a business process in real-time.

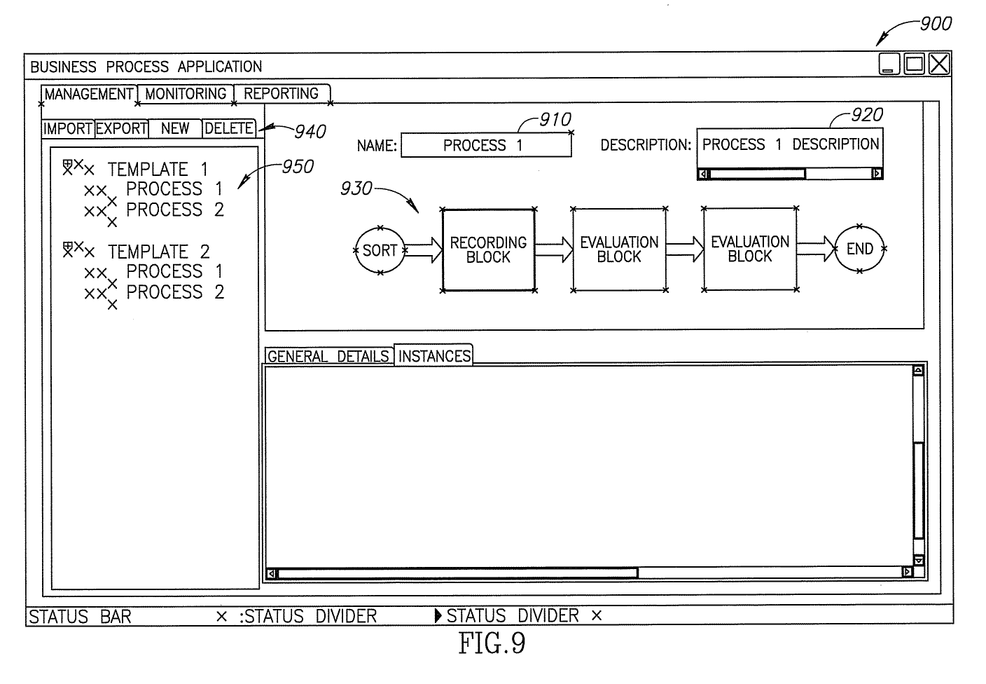

Reference is now made to FIG. 9 showing an exemplary screen shot 900 of an exemplary screen display that may be presented by software tool 810. As shown by 910, a user may be provided with an option to assign a configured business process a name. A business process may be saved under the provided name. The name may also be used to locate and load the business process at a later stage. In block 920, a user may also be enabled to add a description in free text format to a business process, and the description may be saved and/or stored with the definition of a business process.

A user may be enabled to configure or otherwise manipulate service blocks associated with a business process or template by interacting with their graphical representation as shown by 930. For example, by double clicking on one of the service blocks icons shown by 930 a user may be presented with an editing screen where various parameters, configuration items or any applicable aspects associated with the service block may be changed, altered or otherwise manipulated. According to embodiments of the invention, the configurable parameter list presented to a user may vary from one service block to another. For example, double clicking on a reporting service block object may present options to select a reporting method, e.g., email, paging system etc. or a recipient list, while when configuring an analytics service block the analytic algorithm or words to be spotted by a word spotting process may be configured.

In block 940, various authoring functionalities and/or actions may be provided. For example, an import tab may enable a user to select business packages or processes to be imported from an external, possibly remote repository or from another management tool. Likewise, exporting business packages may be done via an export tab as shown. According to embodiments of the invention, a list of template business packages may be presented to a user as shown by 950. A user may select one of such templates to be used as a baseline for a business process. Such a baseline template may be edited by altering various aspects of its service blocks and may further be saved and/or executed as described.

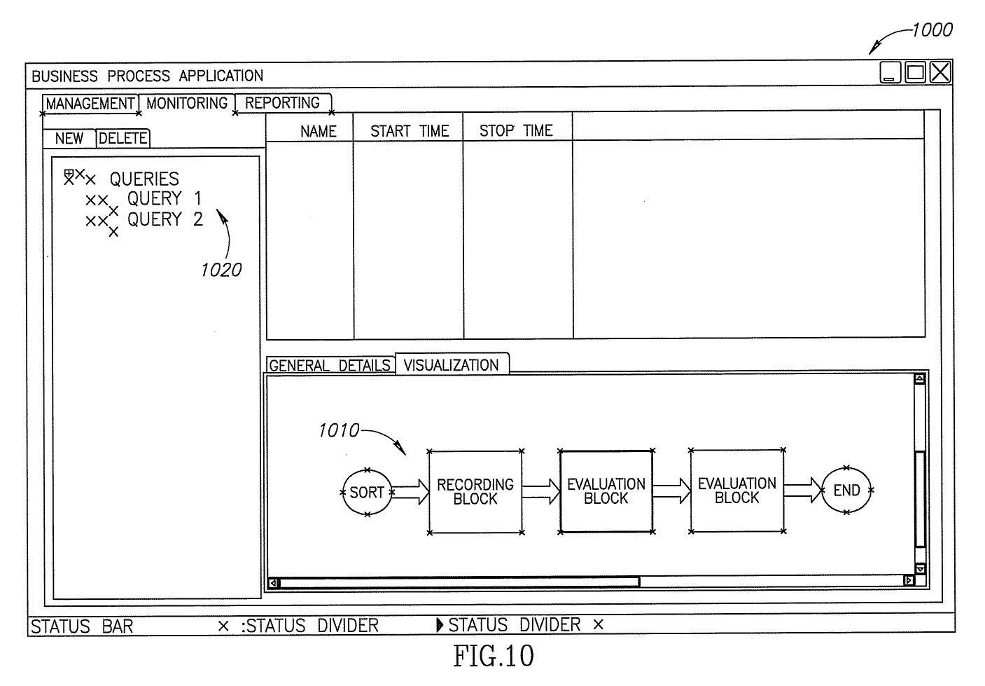

Reference is now made to FIG. 10 showing an exemplary screen shot 1000. Such screen may be presented or displayed to a user by for example a software tool such as tool 810. According to embodiments of the invention and as shown by screen shot 1000, a management tool may enable a user to monitor and/or track an execution progress of a business process. According to embodiments of the invention and as shown by 1010, a graphical representation of a currently executing business process may be provided upon the selection of a user. According to embodiments of the invention and as shown, the business service block currently executing may be marked, for example by highlighting the respective graphical icon, block or other graphical entity. Identifying the service block currently executing within an active business process may enable a user to track and/or monitor an active business process in real-time and respond to various conditions in a timely manner.

According to embodiments of the invention and as shown by 1020, information associated with a selected service block may be presented. According to embodiments of the invention, a user may select one of the service blocks shown by 1010, for example by clicking on it. According to embodiments of the invention, presented information pertaining to the selected service block may be, for example, any results produced so far by the service block, various conditions or constraints pertaining to the execution of the service block and/or any other applicable information, e.g., execution start time and duration, execution warnings or errors etc.

Embodiments may be provided in a computer program product that may include a machine-readable medium, stored thereon instructions, which may be used to program a computer, or other programmable devices, to perform methods as disclosed above. Embodiments of the invention may include an article such as a computer or processor readable medium, or a computer or processor storage medium, such as for example a memory, a disk drive, or a USB flash memory, encoding, including or storing instructions which when executed by a processor or controller, carry out methods disclosed herein.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for implementing a business process, the method comprising:
obtaining a business process template;
modifying said business process template by configuring one or more service blocks associated with said business process template; and
executing a business process according to said modified business process template.

2. The method of claim 1, further comprising storing said modified business process template on a storage device.

3. The method of claim 2, comprising locating said modified business process template on said storage device and executing said modified business process template.

4. The method of claim 1, comprising:
defining a plurality of business processes by applying a respective plurality of configurations to said business process template;
storing said plurality of business processes; and
selecting at least one of said plurality of business processes to execute.

5. The method of claim 1, wherein said service blocks are selected from the list consisting of: a recording service, a work force management service, an analytics service, a mail service, an ERP service, a playback service, a security service, a storage service, a logging service and a QM service.

6. The method of claim 1, wherein executing said business process template comprises invoking services according to one of: simple object access protocol (SOAP) and hyper text transfer protocol (HTTP).

7. The method of claim 1, wherein said business process template is one of: a first call resolution (FCR) business process template, an agent attrition business process template, a customer satisfaction business process template and a customer retention business process template.

8. A system for implementing a business process, the system comprising:
a memory to store a business process template;
a processor to modify said business process template by configuring one or more service blocks associated with said business process template, and to execute a business process according to said modified business process template.

9. The system of claim 8, wherein said processor is to store said modified business process template on a storage device.

10. The system of claim 9, wherein said processor is to locate said modified business process template on said storage device and execute said modified business process template.

11. The system of claim 8, wherein said processor is to:
define a plurality of business processes by applying a respective plurality of configurations to said business process template;
store said plurality of business processes; and
select at least one of said plurality of business processes to execute.

12. The system of claim 8, wherein said service blocks are selected from the list consisting of: a recording service, a work force management service, an analytics service, a mail service, an ERP service, a playback service, a security service, a storage service, a logging service and a QM service.

13. The system of claim 8, wherein executing said business process template comprises invoking services according to one of: simple object access protocol (SOAP) and hyper text transfer protocol (HTTP).

14. The system of claim 8, wherein said business process template is one of: a first call resolution (FCR) business process template, an agent attrition business process template, a customer satisfaction business process template and a customer retention business process template.
